(19) United States
(12) Patent Application Publication
(10) Pub. No.: US 2015/0262213 A1
(43) Pub. Date: Sep. 17, 2015

(54) METHOD AND SYSTEM FOR VALIDATING REDEMPTION REQUESTS

(71) Applicant: HIVE TECHNOLOGY LIMITED, Wymeswold Leicestershire (GB)

(72) Inventor: Merric Mercer, Loughborough (GB)

(21) Appl. No.: 14/433,277

(22) PCT Filed: Oct. 1, 2013
(86) PCT No.: PCT/EP2013/070468

§ 371 Date: Apr. 2, 2015

(30) Foreign Application Priority Data
Oct. 2, 2012 (GB) 1217585.7
Nov. 16, 2012 (GB) 1220597.7

(51) Int. Cl. G06Q 30/02

(52) U.S. Cl. CPC G06Q 30/0225; G06Q 30/0259

(57) ABSTRACT

A method of validating a redemption request comprises the steps of a server: receiving a redemption request from a client computing device, said request including an identifier associated with a specific instance of a product and a location associated with said client request; validating said redemption request at least according to the distance of said location from one or more pre-registered locations; and responsive to validating said redemption request, associating an incentive associated with the purchase of said product to a registered user of said client computing device.

### FIELD

The present invention relates to a method and system for validating redemption requests.

### BACKGROUND

It is known for unique codes to be printed on product packaging so that manufacturers can run promotional, currency and loyalty programs that directly engage the consumer. Consumers are incentivized to buy the product and to provide the unique code from the packaging to a service provider via the Internet. The service provider thus captures the consumer's data and handles the validation of the codes. The unique code provides the manufacturer with a level of confidence that the consumer has indeed purchased the product.

In some cases, the code is printed on the inside of the packaging so that it is not visible to the consumer. This is to prevent consumers from copying the unique codes from the packing while in a retailer outlet, and then using those codes without having purchased the product. However, printing codes on the inside of the pack has significant disadvantages. First, it often adds a new supply or production step and therefore creates significant extra cost. Second, these hidden codes can usually only be applied at the packaging suppliers rather than during the production process and this makes it impractical and expensive to determine the location of specific unique codes in the supply chain. Third, it is unsatisfactory for the consumer, because the consumer has to open the packaging and look for the code before they can use it.

U.S. Pat. No. 6,039,244 is an example of one approach in this field where a unique code is applied to a product so that the code remains invisible to the customer until after the customer purchases the product.

It is an object of the present invention to provide an improved incentive system for distributing and redeeming packaging codes.

### SUMMARY

According to the present invention there is provided a method of validating a redemption request comprising the steps of a server:

receiving a redemption request from a client computing device, said request including an identifier associated with a specific instance of a product and a location associated with said client request;

validating said redemption request at least according to the distance of said location from one or more pre-registered locations; and

responsive to validating said redemption request, associating an incentive associated with the purchase of said product to a registered user of said client computing device.

Preferably, said validating is based on criteria including one or both of said location being: within a distance of one or more specific locations registered for a user; or outside a distance from one or more specified locations common to more than one user.

In a further aspect of the present invention, there is provided a method operable in a client computing device comprising the steps of:

acquiring an identifier associated with a specific instance of a product;

acquiring a location of said client computer from which a redemption request is to be sent; and

sending a redemption request including said identifier and said location to a server for redeeming an incentive associated with the purchase of said product.

This invention employs location information in combination with unique product identifiers including for example, unique codes applied to product packaging and/or a photograph of product packaging possibly including a unique code to improve confidence that a consumer has purchased a product for promotional, currency, loyalty, or refund schemes.

According to a further aspect of the present invention there is provided a method of validating a redemption request comprising the steps of a server:

receiving a redemption request from a client computing device, said request including an identifier associated with a specific instance of a product, said identifier including an image acquired from at least a portion of an individual product package; validating said redemption request at least according whether or not said identifier is unique; and

responsive to validating said redemption request, associating an incentive associated with the purchase of said product to a registered user of said client computing device.

In still further aspects of the present invention there is provided a computer program product stored on a computer readable medium which when executed on a computing device is arranged to perform the steps of either of the above aspects of the present invention.

In still further aspects, there is a provided a server and a client computer respectively configured to perform the steps of either of the above aspects of the present invention.

Embodiments of the invention allow manufacturers to avoid printing codes on product packaging while still providing the manufacturer with confidence that the product has been purchased by a given consumer.

In some embodiments of the invention, manufacturers who elect to use unique codes may print the codes on packaging so they are visible to the consumer while still providing the manufacturer with confidence that the product has been purchased by a consumer redeeming their incentive. In such embodiments, where packaging does carry codes, this provides an additional check against fraudulent use of any scheme.

Regardless, additional risk analysis can be employed to check if any participating consumer might not have purchased a product, such as checking against any customer exhibiting outlying behavior.

### BRIEF DESCRIPTION OF THE DRAWINGS

Embodiments of the invention will now be described, by way of example, with reference to the accompanying drawings, in which:

FIG. 1 is a schematic diagram of a method and system for validating redemption requests according to a first embodiment of the present invention; and

FIG. 2 is a schematic diagram of a method and system for validating redemption requests according to a second embodiment of the present invention.

### DESCRIPTION OF THE PREFERRED EMBODIMENTS

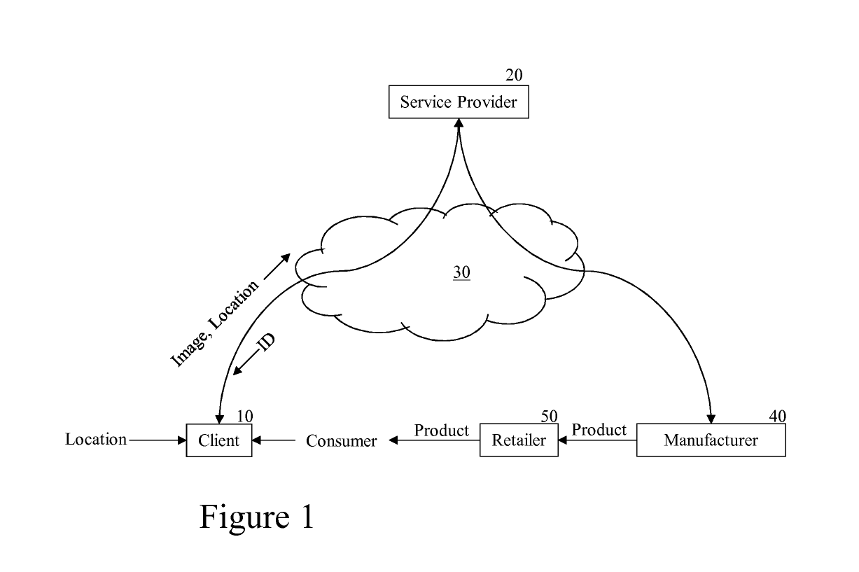

Referring now to FIG. 1 which illustrates a first embodiment of a system according to the present invention. In this example, codes which are used for validating redemption requests are not printed on product packaging.

In embodiments of the invention, a consumer using a client computing device 10 connects to a service provider computer 20 via a network, such as the Internet, 30 to create an account with the service provider. The client application may be a browser which connects to the service provider website; or the client application could comprise a dedicated application or App (for smartphones or tablets) with a connection to a server; or any combination of web service and application. So for example, the consumer might either download an application from an app-store; or once registered, an application might be available for download from the service provider website. In any case, the service provider 20 manages the consumer's account and determines if the consumer has met the proof of purchase criteria set by a manufacturer 40 (only one shown).

In the first embodiment, manufacturers produce and distribute their products to retailers 50 (only one shown) in a conventional manner.

Once a consumer has acquired a product from a retailer, the consumer may wish to record this with the service provider 20 for the purposes of gaining commensurate reward.

Thus, as part of a redemption request, again via a client computer 10 (although not necessarily the same computer as used for registration) connecting using an appropriate client application to the service provider 20, the client receives from the service provider, a code (ID) for the particular product. The service provider application may either select this code from a database; or the code could be generated algorithmically.

Nonetheless, a key requirement is that the code has not previously been used by that same consumer for that particular product. In addition, the code should not be an extension of any previously distributed code to that consumer for that particular product (for example, if a previously distributed code was ‘XYZ’ then the service provider would not send ‘4XYZ1’ as this incorporates the earlier code). The code can be alphabetically or numerical or both. The code could also be a set of symbols or a drawing.

The service provider application gives instructions to the consumer to replicate the provided code on a specific section of the product packaging and then to take a photograph that includes the code and the section of the packaging. The service provider application then enables the consumer to upload the image file to the service provider for validation.

The approach of integrating a code within an image of a portion of the product packaging provides high levels of security and confidence that a consumer has legitimately acquired a product.

Clearly, for such an implementation, the client computer 10 might comprise either a smartphone or tablet computer including a suitable camera or webcam. Alternatively, if the client computer is a general-purpose computer, it can receive the image file from a separate camera for uploading to the service provider.

The image including the code is then validated by the service provider using image processing software which checks that the image uploaded by the consumer includes the same code that was distributed to the consumer for that specific product as well as an identifiable portion of the product packaging. This validation might also be performed manually by an operator viewing the image at a service provider terminal.

Depending on the security requirements of the manufacturer this process can be divided across various applications and appliances or integrated on a single application/device.

In a particular implementation of this embodiment, a dedicated application is provided for the client computer 10 and this application controls the taking and uploading of the image so as to prevent the consumer from doctoring the image or using an image from another source, or from accessing the image taken by application with a photo editing program before the image file is uploaded to the service provider 20.

Embodiments of the invention also take advantage of location information to assist in verifying that a consumer has legitimately acquired a product. This location information is provided by the client 10 along with or for example, within the header of the packaging image file including the code with the client incentive redemption request. Location information for verification can be operated in three ways:

1. Location by Inclusion: In this case, the service provider only validates the incentive request if the image is acquired at a consumer's residential address or at any number of acceptable addresses.

2. Location by Exception: The service provider only validates the incentive request if it is determined that the image was not acquired at certain locations for example designated retail outlets or manufacturing facililties.

3. Location by Inclusion and Exception: Here the location information supplied with the image must meet the requirements of both Inclusion and Exception above.

The acquisition and type of location information which can be used will be explained in more detail below.

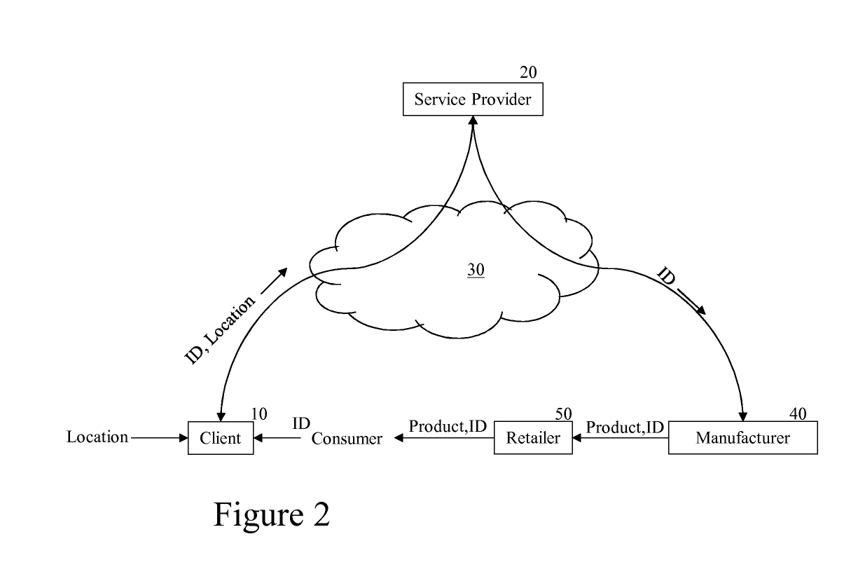

In a second embodiment of the present invention, FIG. 2, codes (IDs) are printed and visible or at least imageable on or within the packaging. These codes can be distributed by the service provider to the manufacturer to print on their products or alternatively, the codes if generated by the manufacturer, they can are distributed back to the service provider. The codes may be either human readable or machine readable, but in general, security is maximized if the unique code is printed as a machine-readable code, rather than a human readable code.

Again in this case, the consumer, once registered with the service provider 20 as in the first embodiment, is prompted to enter the unique code from the pack, using a client application 10.

In some implementations, the client application enables the consumer to scan the machine readable code, for example, a QR code, when running on a device such as a mobile phone and upload it to the service provider, whereas in others, the user manually inputs the human readable code in the client application.

Again, once the code is received from a client, the service provider ensures that the code has been entered to meet one of the three location criteria: inclusion, exclusion or both as outlined above for the first embodiment.

The code, whether part of an image or not, once it is submitted, can be also validated by the service provider in a number of ways:

a) Code Match validation. The service provider checks to ensure that the code either matches a code in a database for the same product or that code has come from a matching self-generated algorithm. The system checks that the code has not been used before for the same product by the same consumer or by another consumer.

b) Code Analysis and Audit. The service provider performs statistical analysis to determine if the consumer's actions are indicative of fraudulent behaviour, by comparing the number of codes entered by the consumer, for a particular product, over a number of time frames and assigning a risk score. The higher the risk score, the higher the likelihood that a review or audit would be triggered.

One form of auditing would require the consumer to perform an extra step before a code is accepted. This step could involve the service provider providing the client with a code as in the first embodiment, requiring the user image the code on the product packaging and returning the image to the service provider for validation as in the first embodiment.

c) The service provider can also limit the number of codes that come from a specific location over a specific time frame. This has two uses: it enables manufactures to restrict the number of codes that can be entered by the occupants of a specific household; and it also prevents multiple consumers attempting to circumvent security by providing a false address (for example the address of a retailer).

In each of the above embodiments, location validation uses the following steps:

1. Determine the location of the consumer when they are either entering/scanning a unique code or acquiring an image of packaging including a code.

The service provider determines the location of the consumer i.e. their client computer 10, by first determining if the computer 10 is connected to the service provider 20 via a wireless router (not shown) mapped to a particular geo-location. If this is the case then the system does not need to use any geo-location capabilities of a 3rd party device or mobile phone. In this case, the geo-location of the router to which the client is connected when the image of the first embodiment is acquired or the code of the second embodiment is input is supplied with the image/code to the service provider for validation.

If the computer 10 is connected via a wireless router whose location is not mapped, then the service provider can use GPS information (if available) from the device 10 at the time the image is acquired or the code is input, and any available location information for any nearby wireless routers to determine the location of the device and then maps this GPS location to the consumer's wireless router, i.e. the system allocates geo-location information from the consumer's client device to the consumer's wireless router and this geo-location information is then used as the consumer's location.

In the event that the computer 10 is not connected via a wireless router then the service provider determines location using the device's geo-location capabilities.

2. Determine whether the location validation method to be performed is ‘Inclusive’ or by ‘Exception’ or a combination of both and perform one of the following:

In the ‘Inclusive method’, at initial registration to the service, the service provider captures the residential address and potentially a range of other addresses from the consumer and converts these into geo-locations, so they can be compared with the geo-location information of the computer 10 at the time the consumer enters the code, or acquires the image of the package and the code. The service provider determines the distance between the two and checks that this is within acceptable and configurable limits.

In the ‘Exclusive method’ the service provider stores a range of unacceptable locations as geo-location information. The service provider compares the distance between the incoming geo-location for a code/image to ensure that the distance between the two is outside the acceptable configured limits from the unacceptable locations.

When combining the two methods above, then the incoming location information associated with an image or code needs to satisfy both the criterion of being within a given distance of the registered residential address and outside a given distance from any unacceptable location.

In a further variant of the first embodiment in particular, time stamp information which is typically included in header of image files can be used for validating a redemption request. This again prevents an image being re-used for multiple redemptions, but it can also ensure that there is no undue delay between first acquiring the image and basing a redemption request on the image.

It is appreciated that even with the above described validation techniques, attempts may still be made to fraudulently participate in the above schemes. For example, a user might image products or scan bar codes at a retailer location and then at another location re-scan the images of the products or bar codes to give the impression purchased products are actually being scanned. For example, if a manufacturer prints unique machine-readable codes onto each pack using an open standard, there is a danger that some consumers will scan the machine readable code whilst in the retailer outlet without purchasing the product. These consumers, having captured the data would then be able to re-create the machine-readable code outside of the store with the aim of bypassing the location security and still benefit from the offer.

A manufacturer could prevent this by printing a proprietary format of machine-readable unique codes onto the packaging. However, this prevents a consumer from scanning the code with a standard reading device in order to get offer or product details.

A further variant of the second embodiment provides an alternative solution to this problem. Here, two machine-readable elements of data are printed on the pack and are associated with one another. Preferably, the elements are printed on the packaging in a manner so that both can be read in a single scan with a scanning device.

One element is ‘public’ and its data can be made readily available the consumer via conventional scanning device/software. The other element is ‘private’ and its data is not readily available to the consumer. This can be achieved by printing two different machine readable formats in the scanning space on the pack, one format is an open standard and contains the public element and the other format is a closed/proprietary standard and contains the private element. Alternatively, a single machine readable format can be printed but altered in such a way that the public element can still be read by all standard scanning devices that support that format, whilst the private element can only be read using a non-standard/proprietary scanning device or proprietary software.

In order to redeem the offer, the consumer thus needs to use a scanning device/software that is able to scan both the public element and the private element as well as meeting the location criteria.

Therefore, this variant, by combining private and public data elements allows marketing flexibility in the retailer whilst maintaining redemption security when used with the location security.

1. A method of validating a redemption request comprising the steps of a server:
receiving a redemption request from a client computing device, said request including an identifier associated with a specific instance of a product and a location associated with said client request;
validating said redemption request at least according to the distance of said location from one or more pre-registered locations; and
responsive to validating said redemption request, associating an incentive associated with the purchase of said product to a registered user of said client computing device.

2. The method of claim 1, wherein said validating is based on criteria including one or both of said location being:
within a distance of one or more specific locations registered for a user; or outside a distance from one or more specified locations common to more than one user.

3. A method operable in a client computing device comprising the steps of:
acquiring an identifier associated with a specific instance of a product;
acquiring a location of said client computer from which a redemption request is to be sent; and
sending a redemption request including said identifier and said location to a server for redeeming an incentive associated with the purchase of said product.

4. A method of validating a redemption request comprising the steps of a server:
receiving a redemption request from a client computing device, said request including an identifier associated with a specific instance of a product, said identifier including an image acquired from at least a portion of an individual product package;
validating said redemption request at least according whether or not said identifier is unique; and
responsive to validating said redemption request, associating an incentive associated with the purchase of said product to a registered user of said client computing device.

5. A computer program product stored on a computer readable medium which when executed on a computing device is arranged to perform the steps of claim 1.

6. A server and a client computer respectively configured to perform the steps of claim 1.
